(19) United States
(12) Patent Application Publication
(10) Pub. No.: US 2013/0276668 A1
(43) Pub. Date: Oct. 24, 2013

(54) FOAMED ASPHALT COMPOSITIONS INCLUDING QUATERNARY ORGANOSILANES

(71) Applicants: Mikhil Ranka, Champaign, IL (US); Moulik Ranka, Champaign, IL (US)

(72) Inventors: Mikhil Ranka, Champaign, IL (US); Moulik Ranka, Champaign, IL (US)

(21) Appl. No.: 13/864,862

(22) Filed: Apr. 17, 2013

Related U.S. Application Data
(60) Provisional application No. 61/636,152, filed on Apr. 20, 2012.

(51) Int. Cl. C08L 95/00

(52) U.S. Cl. CPC C08L 95/005
USPC 106/122; 106/273.1; 524/188; 106/270; 427/242; 427/422

(57) ABSTRACT

The present invention is related to processes for the preparation of asphalt compositions including a step of adding an organosilane composition, including one or more quaternary organosilane compounds, to an asphalt binder to provide a stable foamed asphalt binder composition. The foamed asphalt binder composition can be mixed with, sprayed onto, or otherwise coated substantially over the outer surface on an aggregate to provide an asphalt composition suitable for a variety of paving applications.

### CROSS-REFERENCE TO RELATED APPLICATIONS

This application claims priority to U.S. Provisional Application No. 61/636,152, filed Apr. 20, 2013, the entire contents of which are incorporated herein by reference.

### FIELD OF INVENTION

The present invention relates generally to processes for the preparation of asphalt compositions including a step of adding an organosilane composition, including one or more quaternary organosilane compounds, to an asphalt binder to provide a stable foamed asphalt binder composition. The foamed asphalt binder composition can be mixed with, sprayed onto, or otherwise coated substantially over the outer surface on an aggregate to provide an asphalt composition suitable for a variety of paving applications.

### BACKGROUND OF THE INVENTION

It is known in the art to heat aggregates to 150-170° C. to remove water and mix with a hot asphalt binder (bitumen) at 135-150° C. in the mixing chambers of a drum mix plant or a pug mill batch mix plant or a dual mixer. There have been recent efforts to reduce the temperature during the mixing, laying, and compacting of asphalt mixes. A few major advantages of being able to lower the temperatures associated with the mixing, laying, and compacting steps include a reduction in energy costs for the mix producer, adherence to stringent emission standards, and an ability to pave more easily in cold climatic conditions.

Technologies that allow for a reduction in temperature during the mixing, laying, and compacting of asphalt pavements are commonly known as Warm Mix Asphalt (WMA) technologies. Such technologies generally allow for a temperature reduction in the range of 10-40° C. One such approach includes the practice of foaming an asphalt binder (bitumen) by introducing water into mixes at a temperature above 100° C. For instance, additional efforts have been tried to expand the bitumen by water injection of 1-4% on the bitumen weight, (24 Mar. 2008, Warm Mix Asphalt: Best Practices, NAP A 53rd Annual Meeting—Brian D. Prowell), above 100° C. Addition of water containing zeolite or fillers and water-in-oil emulsion in collar section in the mixing zone are also known in the art.

However, the water injection or zeolite or filler containing water has a disadvantage that the stability of foamed bitumen is poor. In particular, the formed bubbles are large and break easily. As a result, expansion of the bitumen surface and its stabilization during mechanical mixing is very poor resulting in only marginal improvement in coating and workability compared to normal hot mix.

While foamed bitumen technologies are increasingly being preferentially adopted over competing chemical-based WMA technologies due, at least in part, to economical considerations, there are reasonable concerns regarding increased moisture susceptibility of the final pavement because water is intentionally introduced into the asphalt binder. For instance, it has been noted that the presence of water results in lower compressive strength and poor tensile strength ratio (TSR) for Marshall Mix Design or Super Pave Mix Design. Additionally, they offer only a modest temperature reduction as compared to chemical additive technologies, and do not offer the compaction and longer haul distance benefits of chemical based WMA technologies.

As such, there remains a need for a method that can provide the economical benefits of water injection technology and the superior performance benefits of chemical additive technologies.

### SUMMARY OF THE INVENTION

The present invention satisfies at least some of the aforementioned needs by providing a process for preparation of an asphalt composition in which certain embodiments of the present invention can provide both the economical benefits of water injection technology and the superior performance benefits of various chemical additive technologies.

Generally speaking, embodiments of the present invention relate to the process of adding quaternary organosilane compositions as foam stabilizers as part of water injection based technologies for warm mix asphalt (WMA). A more stable foam, as realized by certain embodiments of the present invention, leads to improved aggregate coating over conventional water injection WMA, while the quaternary organosilane compositions also improve the workability of the mix. Uniquely, quaternary organosilane compounds according to certain embodiments of the present invention provide increased hydropobicity to aggregate surfaces, in spite of being water soluble and/or dispersible, via reaction of silanol groups on the aggregate surface with the silanol and/or alkoxy groups on the quaternary organosilanes. That is, the quaternary organosilane composition functions in at least two important respects: (1) stabilizing the foam and (2) providing an increased resistance to debonding (stripping) of the asphalt binder from the aggregate due, at least in part, to the molecular level hydrophobicity provided by the reaction between the quaternary organosilane compounds with the surface of the aggregates.

In accordance with certain embodiments of the present invention, processes for the preparation of an asphalt composition can include a step of heating an asphalt binder (e.g., bitumen) to a temperature sufficient to obtain a flowable asphalt binder and adding (e.g., by water injection) a quaternary organosilane composition to the flowable asphalt binder. Preferably, the quaternary organosilane composition comprises one or more quaternary organosilane compounds dissolved or dispersed in an aqueous-based solvent (e.g., water alone or a mixture of mostly water and one or more alcohols). In certain embodiments, a step of mixing the flowable asphalt binder and the quaternary organosilane composition at a temperature sufficient to provide a foamed asphalt binder composition can be performed. In certain preferred embodiments, this mixing step comprises injecting the quaternary organosilane composition into the flowable asphalt binder. The temperature(s) at which the flowable asphalt binder and the quaternary organosilane composition are introduced to each other or mixed together can often times be carried out at the same temperature or temperature range previously obtained to provide the flowable asphalt binder. The resulting foamed asphalt binder composition can be mixed with, sprayed onto, or otherwise coated onto the surface of one or more types of aggregate to form asphalt composition suitable for a variety of paving applications.

In another aspect, the present invention provides a foamed asphalt binder composition including an asphalt binder, water, and one or more quaternary organosilane compounds, in which the foamed asphalt composition is provided in the form of expanded foam. In accordance with certain embodiments of the present invention, the quaternary organosilane compositions function as an emulsifier and help increase the stability of the foamed asphalt binder composition. Accordingly, the foamed asphalt binder compositions according to certain embodiments of the present invention can beneficially exhibit a foam half-life from about 40 seconds to about 2 minutes. In addition to the increased stability realized by foams according to certain embodiments of the present invention, water soluble quaternary organosilane compositions can simultaneously function as an anti-stripping agent.

### BRIEF DESCRIPTION OF THE SEVERAL VIEWS OF THE DRAWING(S)

Having thus described embodiments of the invention in general terms, reference will now be made to the accompanying drawings wherein:

FIG. 1 shows the half-life of foamed asphalt binder compositions according to certain embodiments of the present invention (Samples B and C) in comparison to the half-life of a comparison foamed asphalt binder (Sample A) that is devoid of a quaternary organosilane compound.

### DETAILED DESCRIPTION OF THE INVENTION

The present invention now will be described more fully hereinafter. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present invention generally provides processes for preparation of foamed asphalt binder compositions, asphalt compositions suitable for a variety of paving applications, and foamed asphalt binder compositions incorporating one or more quaternary organosilane compounds, which are unique in that they can be directly added to asphalt binder, or introduced into an asphalt mix via an aqueous solution and/or dispersion through the water used for foaming to produce a warm mix asphalt composition.

Traditional water injection technologies foam the asphalt binder (e.g., bitumen) via a conversion of water to steam. The volume expansion significantly increases the surface area of bitumen, which leads to an improved ability to coat aggregates at a lower temperature. However, the foaming is relatively short lived and the improved ability to coat aggregates at a lower temperature is entirely dependent on the duration of the foam. Hence, the longer lasting (e.g., more stable) foam achieved by certain embodiments of the present invention beneficially allow for more efficient mixing with aggregate and a further reduction in mixing temperature via water injection WMA.

Surprisingly, quaternary organosilanes have been found to serve as efficient water borne additives that simultaneously improve foam half-life, provide improved workability and increase the moisture resistance of WMA pavements in accordance with certain embodiments of the present invention. Quaternary organosilanes are unique due to the presence of a polar cationic nitrogen and a non-polar organic group, which makes them amphiphilic in nature. Their cationic nature makes them water soluble and/or dispersible, while the non-polar hydrocarbon component makes them easily soluble and/or dispersible in non-polar mixtures such as bitumen. The amphiphilic behavior of the quaternary organolisane compounds, according to certain embodiments of the present invention, is ideally suited to stabilize a non-polar/polar interface such as an expanding steam bubble in bitumen, thereby making quaternary organosilanes excellent foam stabilizers for water injection WMA.

In addition to providing increased stability of foamed asphalt binder compositions, the quaternary organosilanes simultaneously improve the moisture resistance of a final pavement as compared to final pavements devoid of a quaternary organosilane. For instance, quaternary organosilanes are unique in that they are water soluble and/or dispersible, while simultaneously significantly increase the moisture resistance of the resulting pavement.

The ability of quaternary organosilanes to impart improved moisture resistance to asphalt mixes can be understood as follows. The alkoxy groups (e.g., methoxy groups) covalently linked to the Si atom are hydrolyzable, and are involved in the reaction with an inorganic substrate (e.g., aggregate). The bond between the alkoxy groups and the silicon atom is replaced by a siloxane bond between the aggregate surface (which has silanol groups) and the silicon atom. The chemically bound organosilane provides the aggregate surface with an organic layer that is hydrophobic in nature. This makes the aggregate surface significantly more compatible with the incoming asphalt binder (e.g., bitumen), thereby forming a stronger aggregate-bitumen interface that is less susceptible to moisture ingress. Furthermore, the long hydrocarbon portion of the organosilane significantly improves the workability of the mix and enables lower compaction temperatures. These unique set of properties of quaternary organosilanes (i.e., their ability to improve foam stability for water injection, their ability to increase the moisture resistance of the pavement, and their ability to impart improved workability to the mix) makes them ideally suited as additives that enable significantly improved water injection WMA in accordance with certain embodiments of the present invention.

As used herein, the term “asphalt binder” can include bitumen, natural asphalt, oil residue of paving grade, plastic residue from coal tar distillation, petroleum pitch and coal tar. Asphalt binders are customarily used in paving constructions as a glue or binder for aggregate particles. That is, the asphalt binder is used to coat and bind aggregate particles together. These thermoplastic-like materials which soften when heated and harden upon cooling also exhibit viscoelastic properties (e.g., exhibit the mechanical characteristics of viscous flow and elastic deformation) over a certain temperature range.

Asphalt binders, however, are highly complex and not well-characterized materials containing a variety of saturated and unsaturated aliphatic and aromatic compounds. These compounds can often include up to 150 carbon atoms. Particular asphalt binder compositions vary depending on the source of crude oil. Many of the compounds contain oxygen, nitrogen, sulfur, and other heteroatoms. Asphalt binders typically contains about 80% by weight of carbon; around 10% hydrogen; up to 6% sulfur; small amounts of oxygen and nitrogen; and trace amounts of metals such as iron, nickel, and vanadium. The molecular weights of the constituent compounds range from several hundred to many thousands.

A wide variety of asphalt binders may be used in accordance with certain embodiments of the present invention. In general, any paving grade asphaltic binder satisfactory for preparing paving compositions is contemplated as being useful. Paving grade asphaltic binders can have a wide range of penetration values ranging from as low as 30 or 40 dmm for the harder asphalts to 200 to 300 dmm at 25° C. (100 g, sec.) for the softer asphalts. The most widely used paving asphalt binders according to embodiments of the present invention generally have a penetration at 25° C. of about 60 to 100 dmm (e.g., 60-70, 70-80, or 80-100 dmm). In preferred embodiments, however, the asphalt binder remains viscoelastic in all weather conditions.

In certain embodiments of the present invention, the asphalt binder comprises “Bitumen's” and/or “Modified Bitumens” which as used herein, are those which exhibit rheological properties that are appropriate for paving application under specific climatic condition such as those which conform to the Strategic Highway Research Program (SHRP)) pavement binder specification. The bitumen component may be naturally occurring bitumens (such as Trinidad Lake Asphalt and the like), naturally occurring bituminous materials such as gilsonite and gilsonite derivatives, or it can be produced by crude oil or petroleum pitches (such as asphalt) produced during cracking process and coal tar or blends of bituminous materials. The bitumen may also conform to specification of viscosity graded and/or penetration graded bitumens.

Additives which are traditionally added to bitumen to produce a modified bitumen meeting performance-grade standards (such as SHRP) are suitable for use in certain embodiments according to the present invention. Such additives include, but are not limited to, natural rubbers, synthetic rubbers, plastomers, thermoplastic resins, thermosetting resins, elastomers, and combinations thereof. Examples of these additives include styrene-butadienestyrene (SBS), styrene-butadiene rubber (SBR), poly-isoprene, polybutylenes, butadiene-styrene rubbers, vinyl polymers, ethylene vinyl acetate, ethylene vinyl acetate derivatives, and the like. Bitumens used in processes according to embodiments of the present invention can also contain recycled crumb rubber from recycled tires. In certain embodiments, the modified bitumen can contain at least one member selected from the group consisting of sulfur, sulfur-containing crosslinkers, acid modifiers such as tall oil acids, tall oil pitches, and phosphoric acid derivatives and combinations thereof. It is well within the ability of a skilled artisan to produce modified bitumen containing the noted additives.

Where desired, additional additives traditionally employed in the production of bitumen include styrene-butadiene-rubber latex, polyisoprene latex, salts, and the like can be included in certain embodiments according to the present invention. Such additives also include but are not limited to acid modifiers such as poly-phosphoric acid, crude and distilled tall oil acids and tall oil pitches, and derivatives thereof, and wax modifiers such as Montan wax, beeswax, and Fisher-Tropsch waxes, etc.

In certain embodiments, anti-stripping additives like Lime or Hydrated Lime can be used either as powder mixed with aggregates or hydrated lime mixed with water and further mixed with aggregate to marinate at room temperature (e.g., for 10 to 30 hours, particularly 24 hrs).

According to certain embodiments of the present invention, anti-stripping additives which are bitumen soluble/dispersible such as organic amine or quaternary compounds, and silanes having a boiling point above 100° C. can be used as anti-stripping additives in conjunction with quaternary organosilanes according to embodiments of the present invention and added to the asphalt binder (e.g., bitumen) or quaternary organosilane aqueous-based composition added to the asphalt binder for the formation of a stable foam that is exceptional for coating aggregates. The following examples are given for illustrative purposes only as useful compounds according to certain embodiments of the present invention. The following compounds, however, are not an exhaustive list of all useful compounds. That is, the following list of compounds is not limiting and similar compounds within a generic category meeting the 100° C. boiling point criteria can be suitable if desired. For exemplary purposes, compounds such as an organic amine like di-methyl octa decyl amine, poly alkylene poly amines, fatty amido amines derived from C₁₂-C₂₄ fatty acids, ethoxylated C₁₂-C₂₄ monoalkyl amines, etc, quaternary compounds like tri-methyl octa decyl ammonium chloride, di-methyl ethoxy poly 12 hydroxy stearate ammonium di-methyl sulfate salt, etc, silanes such as tri-methoxy propyl silyl octa decyl ammonium chloride, dimethoxy, hydroxy ethoxy propyl silyl octa decyl ammonium chloride, etc. The choice and use of these additives or others does not limit the spirit and scope of this invention.

As previously noted, certain embodiments of the present invention provide processes for preparation of a foamed asphalt binder composition in which an asphalt binder is, preferably initially, heated to a temperature sufficient to obtain a flowable asphalt binder. As used herein, the term “flowable” can include the ability of asphalt binder to flow (e.g., be pumped), spread over a surface, fill pattern recesses, or generally move in any direction against pattern surfaces under pressure. In certain embodiments, the asphalt binder can be heated to a temperature from about 100° C. to about 180° C. (e.g., 110° C. to 170° C., 120° C. to 160° C., or 140° C. to 160° C.) to obtain a flowable asphalt binder. A quaternary organosilane composition can be added in a variety of ways to the flowable asphalt binder. Preferably, however, the quaternary organosilane composition is added to the flowable asphalt binder by water injection, preferably at a temperature comprising from about 130° C. to about 165° C. (e.g., 130° C. to 160° C., 130° C. to 155° C., or 130° C. to 150° C. The quaternary organosilane composition can comprise one or more quaternary organosilane compounds in an aqueous-based solvent. In certain preferred embodiments, an additional step of mixing after the step of adding the quaternary organosilane composition to the flowable asphalt binder, preferably by water injection, is performed at a temperature sufficient to provide a foamed asphalt binder composition is performed. In certain embodiments, for example, the additional mixing step can be performed at a temperature comprising about 130° C. to about 165° C. (e.g., 130° C. to 160° C., 130° C. to 155° C., or 130° C. to 150° C.).

In certain embodiments, the quaternary organosilane composition includes one or more quaternary organosilane compounds provided in an aqueous-based solvent system. For instance, the aqueous-based solvent system can consist of water (i.e., water alone).

Alternatively, the aqueous-based solvent system can comprise one or more organic co-solvents (in addition to water). In certain embodiments, the organic co-solvents can include at least one alcohol. However, suitable organic co-solvents should preferably not negatively impact the stability of the quaternary organosilane compounds. Suitable co-solvents can generally include, but are not necessarily limited to, alcohols (preferably glycols), ketones, ester based solvents and polar acetate solvents.

Examples of alcohols include methanol, ethanol, isopropanol and gylcols; examples of glycols that can be used according to certain embodiments of the present invention include, but are not limited to, ethylene glycol, propylene glycol, ether alcohols such as ethylene glycol, ethylene glycol monoethyl ether and ethylene glycol monobutyl ether; dialkyl ethers of ethylene, ethylene glycolmonoethyl ether, ethylene glycol monobutyl ether, ethylene glycol dibutyl ether, ethylene glycol monoethyl ether acetate, ethylene glycol monohexyl ether acetate, propylene glycol monoethyl ether, and propylene glycol dibutyl ether; the mono- and dialkylethers of diethylene glycol such as diethylene glycol monoethyl ether, diethylene glycol dibutyl ether, diethylene glycol diethyl ether, and diethylene glycol monobutyl ether acetate.

Examples of ketones that can be used according to certain embodiments of the present invention include, but are not limited to, acetone, acetophenone, butanone, cyclohexanone, ethyl isopropyl ketone, diacetone, isophorone, methyl isobutyl ketone, methyl isopropyl ketone, methylethyl ketone, methylamyl ketone, and 3-pentanone.

Examples of ester based solvents and acetate solvents that can be used according to certain embodiments of the present invention include, but are not limited to, benzyl benzoate, butyl acetate, methyl acetate, ethyl acetate, n-propyl acetate, isobutyl acetate, isoamyl acetate, isopropyl acetate, n-butyl acetate, isobutyl acetate, amyl acetate, sec-butyl acetate, tert-butyl acetate, ethyl acetate, ethyl acetoacetate, methyl acetate propyl acetate, ethylene glycol monomethyl ether acetate and ethylene glycol monoethyl ether acetate.

The quaternary organosilane composition includes one or more quaternary organosilane compounds. As noted above, the quaternary organosilane compounds exhibit several beneficial properties for the preparation of asphalt pavement compositions for a variety of applications. In certain embodiments of the present invention, the one or more quaternary organosilane compounds include both a polar cationic nitrogen and a non-polar organic functional group. Compounds with these structural attributes are amphiphilic in nature. The amphiphilic behavior of the quaternary organolisane compounds, according to certain embodiments of the present invention, is ideally suited to stabilize a non-polar/polar interface such as an expanding steam bubble in bitumen, thereby making quaternary organosilanes excellent foam stabilizers.

In addition to providing increased stability of foamed asphalt binder compositions, the quaternary organosilanes simultaneously improve the moisture resistance of a final pavement as compared to final pavements devoid of a quaternary organosilane. For instance, quaternary organosilanes are unique in that they are water soluble and/or dispersible, while simultaneously significantly increase the moisture resistance of the resulting pavement. Debonding of asphalt binder from aggregate is a major issue in asphalt pavement applications and in particular for traditional water injection technologies since the incomplete evaporation of injected water leads to poor bonding and increased moisture sensitivity. Since quaternary organosilane compounds, in accordance with embodiments of the present invention, are primarily reactive water soluble emulsifiers that substantially improves the bonding between asphalt binder and aggregate, addition of these compounds through water addition (e.g., water injection) can be ideal because the presence of water will ensure that the silanol groups hydrolyze and react with the aggregate to provide molecular level hydrophobicity.

In certain embodiments, all of the quaternary organosilane compounds are soluble in water. As such, the quaternary organosilane composition can comprise a solution of quaternary organosilane compounds in the aqueous based solvent (e.g., preferably water alone). In such embodiments, one or more quaternary organosilane compounds can simply be dissolved in the aqueous based solvent (e.g., preferably water alone) prior to addition/mixing (e.g., water injection) into the flowable asphalt binder. In certain alternative embodiments, not all of the one or more quaternary organosilane compounds is not water soluble. In such, cases, the quaternary organosilane composition can comprise a dispersion of quaternary organosilane compounds (while some other compounds may be simultaneously dissolved therein).

In certain embodiments, the quaternary organosilane composition can comprise a solution or dispersion of from about 0.01 to about 20% (e.g., 0.01 to 10%, 0.01 to 5%, 0.01 to 1%, 0.1 to 10%, 0.1 to 5%, or 0.1 to 1%) by weight of quaternary organosilane compounds in the aqueous based solvent (e.g., preferably water alone).

In certain embodiments according to embodiments of the present invention, the step of adding a quaternary organosilane composition to the flowable asphalt binder comprises injecting the quaternary organosilane composition into the flowable asphalt binder. Preferably, the quaternary organosilane composition is injected into the flowable asphalt binder via a nozzle or valve. After initial injection into the flowable asphalt binder, an additional or further mixing of the quaternary organosilane composition into/throughout the flowable asphalt binder can be carried out in a traditional manner, in accordance with certain embodiments, known to one skilled in the art of WMA foam injection technologies. Preferably, this additional mixing is carried out at a temperature sufficient to provide a foamed asphalt binder composition. In certain embodiments, for example, the additional mixing step can be performed at a temperature comprising about 130° C. to about 165° C. (e.g., 130° C. to 160° C., 130° C. to 155° C., or 130° C. to 150° C.).

In certain embodiments, the resulting foamed asphalt binder composition comprises an expanded volume in comparison to the pre- or non-expanded volume of the flowable asphalt binder. For instance, the expanded volume is from about 5% to about 80%, 5% to about 60%, 5% to about 35%, from about 20% to about 60%, from about 30% to about 50%, or from about 40% to about 50% larger than the non-expanded volume of the flowable asphalt binder.

In certain embodiments, the resulting foamed asphalt binder composition comprises a foam half-life from about 30 seconds to about 5 minutes, 40 seconds to about 4 minutes, 40 seconds to about 3 minutes, 40 seconds to about 2 minutes, 1 minute to about 5 minutes, or from about 2 minutes to about 3 minutes. Foam half-life is defined as the time it takes from the start of the foaming process, for the foamed asphalt binder composition to recede to half the maximum height achieved during foaming. One hypothetical for illustrating the calculation/determination of the foam half-life is as follows: the onset of foaming begins at T (onset)=0 seconds; maximum foam volume and/or height is achieved at T(max)=10 seconds; and the foam volume and/or height reaches ½ of maximum value at T(half)=60 seconds. The foam half-life of this hypothetical scenario would be 60 seconds.

The foamed asphalt binder composition, according to certain embodiments of the present invention, can comprise from about 0.001% to about 5% by weight of the one or more quaternary organosilane compounds.

The quaternary organosilane composition, according to certain embodiments of the present invention, can comprise one or more one or more quaternary organosilane compounds comprising at least one alkoxy group. In certain preferred embodiments, the at least one alkoxy group comprises ethylene glycol or polyethylene glycol functionality. The at least one alkoxy group can comprise ethylene glycol or polyethylene glycol functionality bonded to a silicon atom.

In certain preferred embodiments, the one or more quaternary organosilane compounds can be selected from the following:

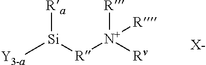

wherein:

Y is independently selected from moieties that hydrolyze to liberate a mono or poly hydroxyl compound (e.g., Y can be RO where R is (CH2CH2O)n H where n has a value of one through ten, (CH3OCH2CH2O), or (CH3CH2OCH2CH2O) radical, or [OC3H5]n OH (propylene glycol) radical where n has a value of one through ten, or [C3H7O3], (glycerol) radical), or Y is independently selected from OH;

a has a value of zero, one and two;

R′ is a methyl or ethyl radical;

R″ is a C1-C4 alkylene group;

R′″, R″″ and R^{v} are alkyl groups containing one to twenty two carbon atoms wherein at least one such group is larger than eight carbon atoms, —CH2C6H5, —CH2CH2OH, —CH2OH, and —(CH2)xNHC(O)R^{v} wherein x has a value of from two to ten and R^{v} is a perfluoroalkyl radical having one to twelve carbon atoms; and

X is chloride, bromide, fluoride, iodide, acetate or tosylate;

In yet additional preferred embodiments, the one or more quaternary organosilane compounds can be selected from the following:

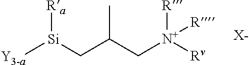

wherein:

Y is independently selected from moieties that hydrolyze to liberate a mono or poly hydroxyl compound (e.g., Y can be RO where R is an alkyl group with one to four carbons, (CH2CH2O)n H where n has a value of one through ten), or Y is independently selected from OH;

a has a value of zero, one and two;

R′ is a methyl or ethyl radical;

R′″, R″″ and R^{v} are alkyl groups containing one to twenty two carbon atoms wherein at least one such group is larger than eight carbon atoms, —CH2C6H5, —CH2CH2OH, —CH2OH, and —(CH2)xNHC(O)R^{v} wherein x has a value of from two to ten and R^{v} is a perfluoroalkyl radical having one to twelve carbon atoms; and

X is chloride, bromide, fluoride, iodide, acetate or tosylate.

In yet a further aspect, the present invention provides processes for the preparation of asphalt compositions suitable for a variety of paving applications. In certain embodiments, the processes can include, as described above, a step heating an asphalt binder to a temperature sufficient to obtain a flowable asphalt binder and adding a quaternary organosilane composition to the flowable asphalt binder as discussed above. The quaternary organosilane composition comprises one or more quaternary organosilane compounds dissolved and/or dispersed in an aqueous-based solvent as described above. Preferably, the quaternary organosilane composition and flowable asphalt binder are subjected to an additional or further mixing to facilitate a homogenous distribution of the quaternary organosilane composition throughout the flowable asphalt binder and at a temperature sufficient to provide a foamed asphalt binder composition suitable for coating a variety of aggregate materials. The foamed asphalt binder composition can be mixed with, sprayed onto, or otherwise coated onto the surface of a variety of aggregate materials to form the asphalt composition suitable for a wide variety of asphalt paving applications. In certain embodiments, the foamed asphalt binder composition can be mixed with, sprayed onto, or otherwise coated onto the surface of a variety of aggregate materials at a temperature comprising from about 220° F. to about 280° F. (e.g., 220° F. to 270° F., 240° F. to 270° F., 220° F. to 250° F., 220° F. to 240° F.).

Aggregate used in paving materials and road construction, road rehabilitation, road repair, and road maintenance are derived from natural and synthetic sources. As in any construction process, aggregates are selected for asphalt paving application based on a number of criteria, including physical properties, compatibility with the bitumen to be used in the construction process, availability, and ability to provide a finished pavement that meets the performance specifications of the pavement layer for the traffic projected over the design life of the project. Among the aggregate properties that are key to successful road construction is gradation, which refers to the percent of aggregate particles of a given size. For most load-bearing asphalt pavements, three gradations are common: dense-graded, gap-graded and open-graded. Dense-graded aggregate exhibit the greatest mineral surface area (per unit of aggregate). Open-graded aggregate largely consist of a single, large-sized (e.g., around 0.375 to 1.0 inch) stone with very low levels (typically less than about two percent of the total aggregate) of fines (material less than 0.25 inch) or filler (mineral material less than 0.075 mm). Gap-graded aggregate fall between dense-graded and open-graded classes. Reclaimed asphalt pavement (RAP) material generally reflects the gradation of the pavement from which the reclaimed material was obtained. If the original pavement was a dense-graded mix, the RAP generally will also be dense graded, although the filler content is generally observed to be lower than the design limits of the original aggregate specifications.

Any aggregate which is traditionally employed in the production of bituminous paving compositions is suitable for use in certain embodiments according to the present invention, including dense-graded aggregate, gap-graded aggregate, open-graded aggregate, stone-matrix asphalt, recycled asphalt paving, and mixtures thereof. In certain embodiments, aggregate which is not fully dried can be employed. In such embodiments, for instance, pretreatment of the aggregate with an anti-stripping agent can be performed, if so desired. Drying and/or pre-treatment of the aggregate are optional steps in accordance to certain embodiments of the present invention. That is, the concern of a residual moisture content associated with the premixed (i.e., prior to be coated/mixed with an asphalt binder) aggregate is significantly mitigated by the incorporation of a quaternary organosilane in accordance to embodiments of the present invention.

In accordance with certain embodiments of the present invention, aggregates or mineral aggregates can comprise coarse particulate materials used in construction, including sand, gravel, crushed stone, soil, slag, recycled concrete, or mixtures thereof. Mineral fillers can also be utilized as aggregates which typically include dolomite, granites, river-bed crushed gravel, sandstone, limestone, basalt and other inorganic stones which can be added to the system. As referenced above, the particular aggregates, sand, soils etc. used in certain embodiments of the present invention are generally not critical as long as they have functional groups or reactive sites (e.g., silanol groups) on the surface that will bond with the silanols created by hydrolysis of the silane alkoxy groups.

In accordance with certain embodiments, the step of mixing the foamed asphalt binder composition and aggregate can comprise the use of drum mixers, pug mill batch mixers, static mixers, or dual mixers to coat the aggregate with the foamed asphalt binder composition. In certain alternative embodiments of the present invention, the step of mixing the foamed asphalt binder composition and aggregate comprises coating the aggregate with the foamed asphalt binder composition by spraying the foamed asphalt binder composition onto the aggregate through one or more nozzles, valves, or combination thereof.

In yet another aspect, the present invention provides foamed asphalt binder compositions exhibiting improved stability and are particularly well suited for coating of a large variety of aggregates for the ultimate formation of asphalt compositions that exhibit remarkable resistance to stripping and are suitable for a variety of paving applications.

In certain embodiments, the foamed asphalt binder compositions comprise an asphalt binder (e.g., bitumen), water, and one or more quaternary organosilane compounds in accordance with embodiments of the present invention. In certain embodiments, the resulting foamed asphalt binder composition comprises an expanded volume in comparison to the pre- or non-expanded volume of the flowable asphalt binder. For instance, the expanded volume is from about 5% to about 80%, 5% to about 60%, 5% to about 35%, from about 20% to about 60%, from about 30% to about 50%, or from about 40% to about 50% larger than the non-expanded volume of the flowable asphalt binder.

In certain embodiments, the resulting foamed asphalt binder composition comprises a foam half-life from about 30 seconds to about 5 minutes, 40 seconds to about 4 minutes, 40 seconds to about 3 minutes, 40 seconds to about 2 minutes, 1 minute to about 5 minutes, or from about 2 minutes to about 3 minutes.

The foamed asphalt binder composition, according to certain embodiments of the present invention, can comprise from about 0.001% to about 5% by weight of the one or more quaternary organosilane compounds.

As described above, the foamed asphalt binder compositions according to certain embodiments of the present invention can be mixed with, sprayed onto, or otherwise coated onto the outer surface of a variety of aggregates to provide an asphalt composition suitable for a variety of paving applications. That is, the asphalt compositions can be applied to a surface to be paved by methods know by those skilled in the art. Once applied to the surface to be paved, the asphalt compositions according to embodiments of the present invention can be compacted using any of the compaction methods traditionally employed for paving applications. Preferably, the applied asphalt compositions can be compacted to an air void content comparable or lower to hot mix pavement compositions made at 15-25° C. higher temperatures having substantially equivalent aggregate gradation and bitumen content. Certain embodiments of the present invention can beneficially be compacted at a reduced temperature relative to preparations devoid of quaternary organosilane compositions in accordance with embodiments of the present invention. For instance, conventional compaction temperatures range from 120° C. to 130° C. The ability to compact embodiments of the present invention at reduced temperatures relative to the conventional temperatures is beneficially realized with embodiments of the present invention. Certain embodiments of the present invention can, for example, be compacted at a temperature from about 90° C. to about 115° C. (e.g., 90° C. to 105° C., 90° C. to 100° C., or 90° C. to 100° C.).

According to certain embodiments of the present invention, the ability/properties that enable the reduced preparation and compaction temperatures provides several immediately apparent results. For example, a 15° C. to 25° C. reduction in preparation temperature can lead to a significant reduction in fuel consumption as well as reducing the production of CO₂ per ton of asphalt mix. Additionally, the reduced temperatures can help mitigate the exposure of workers to any volatile organic vapors and odors associated with bitumen. Furthermore, workers during summer months, for example, find it especially difficult to work with hot mixes and the lowering of the preparation and compaction temperatures mitigates the level of heat stress realized by workers.

It another aspect, it may be further preferred that the applied asphalt compositions be compacted to develop load-bearing strength comparable to hot mix pavement compositions made at 15-35° C. higher temperatures and having substantially equivalent aggregate gradation and bitumen content.

Furthermore, embodiments of the present invention are suitable for use in thin lift overlay paving applications. The current thin lift technology using hot-mix bituminous compositions commonly suffers from two chief deficiencies. The hot bituminous compositions tend to cool quickly, making it difficult to spread on the existing pavement surface (at ambient temperatures) that is in need of repair. This rapid cooling of the thin lift of hot bituminous material can also result in relatively poor compaction.

Where desired, embodiments of the present invention can be used in in-situ production of asphalt compositions. Such in-situ operations include on-site recycling operations such as hot in-place recycling where an aged, distressed pavement may be heated with a variety of portable heater units, scarified, and re-combined with asphalt binder to create a rejuvenated paving composition. The rejuvenated paving composition can be immediately extended over the width of the traffic lane and compacted to create a rejuvenated pavement riding surface.

Asphalt compositions according to embodiments of the present invention can preferably be maintained in range of 80-150° C. (preferably in range of 90-120° C. during the production and then use in paving application). In some instances, it may be preferred to maintain the asphalt compositions at these temperatures in closed systems like large stock silos, storage silos, covered transport vehicles and like to ensure the availability at site under these temperature conditions.

The following examples are provided to further illustrate aspects of the present invention and are not to be construed as limiting the invention in any manner.

### EXAMPLES

A 65 wt % solution of 3-(trimethoxysilyl)propyldimethyloctadecyl ammonium chloride in benzyl alcohol was added to tap water to make aqueous solutions of 0.00%, 1.0% and 2.0% by weight (Sample A, Sample B, and Sample C, respectively). A foaming test was carried out in “The Foamer”, a commercially available laboratory scale foamer sold by Pavement Technology Inc., Covington, Ga., USA. In particular, a 3% by weight of the aqueous solutions (Sample A, Sample B, and Sample C, respectively) were injected into bitumen at 270° F. The foam half-life of each was measured. Foam half-life is defined as the time it takes from the start of the foaming process, for the foamed asphalt binder composition to recede to half the maximum height achieved during foaming.

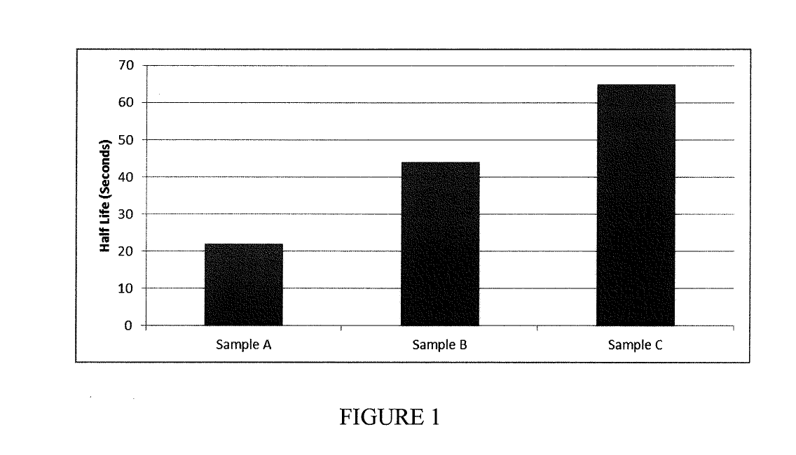

As can be seen in FIG. 1, Sample A, which was devoid of an organosilane compound, exhibited a foam half-life of about 22 seconds. Samples B and C, however, each exhibited a greater foam half-life due to the presence of 3-(trimethoxysilyl)propyldimethyloctadecyl ammonium chloride incorporated into the foamed bitumen composition. As shown on FIG. 1, the half-life of Sample C was greater than that of Sample B due to the greater concentration of 3-(trimethoxysilyl)propyldimethyloctadecyl ammonium chloride in Sample C.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for preparation of a foamed asphalt binder composition comprising:
heating an asphalt binder to a temperature sufficient to obtain a flowable asphalt binder;
adding a quaternary organosilane composition to the flowable asphalt binder, said quaternary organosilane composition comprising one or more quaternary organosilane compounds in an aqueous-based solvent; and
mixing the flowable asphalt binder and the quaternary organosilane composition at a temperature sufficient to provide a foamed asphalt binder composition.

2. A process according to claim 1, wherein the aqueous-based solvent comprises a mixture of water and at least one alcohol.

3. A process according to claim 1, wherein the aqueous-based solvent consists of water.

4. A process according to claim 1, wherein the one or more quaternary organosilane compounds include (i) a polar cationic nitrogen and (ii) a non-polar organic functional group.

5. A process according to claim 4, wherein at least one of the one or more quaternary organosilane compounds is water soluble.

6. A process according to claim 4, wherein all of the one or more quaternary organosilane compounds are water soluble.

7. A process according to claim 1, wherein the asphalt binder is heated to a temperature from about 100° C. to about 180° C. to obtain a flowable asphalt binder.

8. A process according to claim 1, wherein the step of adding a quaternary organosilane composition to the flowable asphalt binder comprises injecting the quaternary organosilane composition into the flowable asphalt binder.

9. A process according to claim 8, wherein the quaternary organosilane composition is injected into the flowable asphalt binder via a nozzle or valve.

10. A process according to claim 1, wherein the foamed asphalt binder composition comprises an expanded volume, said expanded volume is from about 5% to about 35% larger than a non-expanded volume of the flowable asphalt binder.

11. A process according to claim 1, wherein the foamed asphalt binder composition comprises a foam half-life from about 40 seconds to about 240 seconds.

12. A process according to claim 1, wherein the one or more quaternary organosilane compounds comprise at least one alkoxy group comprising ethylene glycol or polyethylene glycol functionality, said at least one alkoxy group comprising ethylene glycol or polyethylene glycol functionality being bonded to a silicon atom.

13. A process according to claim 1, wherein the one or more quaternary organosilane compounds are selected from the following: 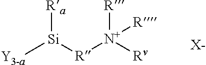
wherein:
Y is independently selected from moieties that hydrolyze to liberate a mono or poly hydroxyl compound, or Y is independently selected from OH;
a has a value of zero, one and two;
R′ is a methyl or ethyl radical;
R″ is a C1-C4 alkylene group;
R′″, R″″ and R^{v} are alkyl groups containing one to twenty two carbon atoms wherein at least one such group is larger than eight carbon atoms, —CH₂C₆H₅, —CH₂CH₂OH, —CH₂OH, and —(CH₂)ₓNHC(O)R^{v} wherein x has a value of from two to ten and R^{v} is a perfluoroalkyl radical having one to twelve carbon atoms; and
X is chloride, bromide, fluoride, iodide, acetate or tosylate.

14. A process according to claim 13, wherein the one or more quaternary organosilane compounds are selected from the following: 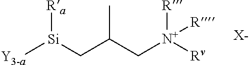
wherein:
Y is independently selected from moieties that hydrolyze to liberate a mono or poly hydroxyl compound, or Y is independently selected from OH;
a has a value of zero, one and two;
R′ is a methyl or ethyl radical;
R″ is a C1-C4 alkylene group;
R′″, R″″ and R^{v} are alkyl groups containing one to twenty two carbon atoms wherein at least one such group is larger than eight carbon atoms, —CH₂C₆H₅, —CH₂CH₂OH, —CH₂OH, and —(CH₂)ₓNHC(O)R^{v} wherein x has a value of from two to ten and R^{v} is a perfluoroalkyl radical having one to twelve carbon atoms; and
X is chloride, bromide, fluoride, iodide, acetate or tosylate.

15. A process according to claim 1, wherein the foamed asphalt binder composition comprises from about 0.001% to about 20% by weight of the one or more quaternary organosilane compounds.

16. A process for preparation of an asphalt composition comprising:
heating an asphalt binder to a temperature sufficient to obtain a flowable asphalt binder;
adding a quaternary organosilane composition to the flowable asphalt binder, said quaternary organosilane composition comprise one or more quaternary organosilane compounds dissolved or dispersed in an aqueous-based solvent;
mixing the flowable asphalt binder and the quaternary organosilane composition at a temperature sufficient to provide a foamed asphalt binder composition; and
mixing the foamed asphalt binder composition and aggregate to form the asphalt composition.

17. A process according to claim 16, wherein the aqueous-based solvent consists of water, alcohol, or a combination thereof.

18. A process according to claim 16, wherein the one or more quaternary organosilane compounds include (i) a polar cationic nitrogen and (ii) a non-polar organic functional group; and at least one of the one or more quaternary organosilane compounds is water soluble.

19. A process according to claim 16, wherein the step of adding a quaternary organosilane composition to the flowable asphalt binder comprises injecting the quaternary organosilane composition into the flowable asphalt binder.

20. A process according to claim 19, wherein the quaternary organosilane composition is injected into the flowable asphalt binder via a nozzle or valve.

21. A process according to claim 16, wherein the one or more quaternary organosilane compounds comprise at least one alkoxy group comprising ethylene glycol or polyethylene glycol functionality, said at least one alkoxy group comprising ethylene glycol or polyethylene glycol functionality being bonded to a silicon atom.

22. A process according to claim 16, wherein said step of mixing the foamed asphalt binder composition and aggregate comprises the use of drum mixers, pug mill batch mixers, static mixers, or dual mixers to coat the aggregate with the foamed asphalt binder composition.

23. The process according to claim 16, wherein said step of mixing the foamed asphalt binder composition and aggregate comprises coating the aggregate with the foamed asphalt binder composition by spraying the foamed asphalt binder composition onto the aggregate through one or more nozzles, valves, or combination thereof.

24. A foamed asphalt binder composition, comprising:
an asphalt binder;
water; and
one or more quaternary organosilane compounds, said foamed asphalt binder composition is in the form of an expanded foam.

25. A foamed asphalt binder composition according to claim 24, wherein the foamed asphalt binder composition comprises a foam half-life from about 40 seconds to about 240 seconds.

26. A foamed asphalt binder composition according to claim 24, wherein the asphalt binder comprises bitumen.

27. A foamed asphalt binder composition according to claim 26, wherein the bitumen is selected from naturally occurring bitumen, naturally occurring bituminous materials, bitumen from crude oil, bitumen from petroleum pitches, bitumen from coal tar, and combinations thereof

28. A foamed asphalt binder composition according to claim 26, wherein the bitumen is selected from polymer-modified bitumen, rubberized bitumen, acid modified bitumen, wax modified bitumen, and combinations thereof.

29. A foamed asphalt binder composition according to claim 28, wherein the polymer-modified bitumen is at least one member selected from the group consisting of styrenebutadiene-styrene, styrene-butadiene rubber polyisoprene, polybutylenes, butadiene-styrene rubbers, vinyl polymers or ethylene vinyl acetate copolymer.

30. A foamed asphalt binder composition according to claim 28, wherein the asphalt binder comprises bitumen that is modified with recycled crumb rubber from recycled tires, sulfur containing crosslinkers, acid modifiers, or combinations thereof.
